(19) United States
(12) Patent Application Publication
(10) Pub. No.: US 2025/0199885 A1
(43) Pub. Date: Jun. 19, 2025

(54) SYSTEMS AND METHODS FOR REDUCING SPOILAGE OF SINGLE-APPLICATION CODES USING AUTOMATED INJECTION VIA A MODIFIED USER INTERFACE

(71) Applicant: Capital One Services, LLC, McLean, VA (US)

(72) Inventors: John ADJEI, Gainesville, VA (US); Kendra FLORIO, Sterling, VA (US); Joshua EDWARDS, Philadelphia, PA (US); Kevin OSBORN, Newton Highlands, MA (US); Jordan RIDENOUR, Chicago, IL (US)

(73) Assignee: Capital One Services, LLC, McLean, VA (US)

(21) Appl. No.: 18/543,389

(22) Filed: Dec. 18, 2023

(51) Int. Cl. G06F 9/54; G06F 9/451

(52) U.S. Cl. CPC G06F 9/542; G06F 9/451

(57) ABSTRACT

A procedure for modifying a user interface may include causing a first application on a user device to monitor an electronic session of a second application on the user device. The first application may determine a characteristic of the electronic session, query an API using the determined characteristic for a relevant single-application code, and receive a response back from the API. The first application may detect an activation of a user interface element associated with completing an interaction on the electronic session. In response to the detection, the first application may interrupt a response of the second application to the activation. During the interruption, the first application may modify the interaction, e.g., by injecting execution of the single-application code into the second application, and then cause the response of the second application to resume with the modified interaction.

### TECHNICAL FIELD

Various embodiments of this disclosure relate generally to modifications of a user interface, and, more particularly, to systems and methods for reducing spoilage of single-application codes using automated injection via a modified user interface.

### BACKGROUND

Single-use codes have attained wide usage in a variety of situations such as authentication, security, e-commerce, and others. By only being usable once, such codes may increase security, reduce unintentional usage, facilitate use tracking, etc. However, only being usable once can also result in spoliation, e.g., expiration of a single-use code without achieving a related purpose or completing a related action or interaction. In an example, a limited quantity of single-use offers for e-commerce enable an efficient means to emplace limitations on the loss in value incurred by an entity as a result of the offer. However, in some cases, a user may request a single-use offer, resulting in expiration of a corresponding single-use code, but then not actually complete an e-commerce interaction with the entity. Such spoliation thus represents an inefficiency in the overall offer. Moreover, with the expiration of the single-use code, the opportunity for another user who will complete an e-commerce interaction with the entity to use the code may be lost.

This disclosure is directed to addressing one or more challenges such as those referenced above. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for reducing spoilage of single-application codes using automated injection via a modified user interface.

In one aspect, a computer-implemented method for modifying a user interface may include: causing a first electronic application operating on a user device to monitor an electronic session of a second electronic application operating on the user device; determining, via the first electronic application and based on the monitoring, one or more characteristics of the electronic session; querying, via the first electronic application and using the determined one or more characteristics, an Application Programming Interface (API) for one or more single-application codes relevant to the electronic session; receiving, from the API, the one or more single-application codes; detecting, via the first electronic application and based on the monitoring, an activation of a user interface element associated with completing an interaction on the electronic session; in response to the detecting of the activation: interrupting a response of the second electronic application to the activation; while the response is interrupted, modifying the interaction on the electronic session by injecting execution of at least one of the one or more single-application codes into the second electronic application; and causing the response of the second electronic application to the activation to resume with the modified interaction.

In another aspect, a computer-implemented method for modifying a user interface may include: causing a first electronic application operating on a user device to monitor an electronic session of a second electronic application operating on the user device; determining, via the first electronic application and based on the monitoring, that a user is engaged in an interaction to obtain an item offered by an entity via the electronic session; querying, via the first electronic application, an Application Programming Interface (API) for an availability of one or more single-application codes relevant to the one or more of the item and the entity; receiving, from the API, an indication of the availability of one or more single-application codes; in response to receiving the indication of availability, causing the first electronic application to insert a visual notification into the electronic session that is indicative of one or more of an availability or effect of the one or more single-application codes on the interaction, wherein the one or more single-application codes are withheld from the user and the electronic session; detecting, via the first electronic application and based on the monitoring, an activation of a user interface element associated with completing the interaction on the electronic session; in response to the detecting of the activation: interrupting a response of the second electronic application to the activation; while the response is interrupted, modifying the interaction on the electronic session by injecting execution of at least one of the one or more single-application codes into the second electronic application in a background context such that the at least one of the one or more single-application codes is neither provided nor available to the user and to the electronic session; and causing the response of the second electronic application to the activation to resume with the modified interaction.

In a further aspect, a non-transitory computer-readable medium may include instructions for modifying a user interface on a user device. The instructions may be executable by at least one processor of the user device to perform operations, including: causing a first electronic application operating on the user device to monitor an electronic session of a second electronic application operating on the user device; determining, via the first electronic application and based on the monitoring, one or more characteristics of the electronic session; querying, via the first electronic application and using the determined one or more characteristics, an Application Programming Interface (API) for one or more single-application codes relevant to the electronic session; receiving, from the API, the one or more single-application codes; detecting, via the first electronic application and based on the monitoring, an activation of a user interface element associated with completing an interaction on the electronic session; in response to the detecting of the activation: interrupting a response of the second electronic application to the activation; while the response is interrupted, modifying the interaction on the electronic session by: injecting execution of at least one of the one or more single-application codes into the second electronic application; and modifying the user interface element to include a visual indication of the executing of the at least one of the one or more single-application codes; causing the response of the second electronic application to the activation to resume with the modified interaction; and transmitting an indication of expiration of the at least one of the one or more single-application codes to the API.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment for modifying a user interface, according to one or more aspects of the disclosure.

FIG. 2 illustrates an exemplary process for modifying a user interface, according to one or more aspects of the disclosure.

FIG. 3 is a functional block diagram of a computer, according to exemplary embodiments of the present disclosure.

### DETAILED DESCRIPTION OF EMBODIMENTS

Certain aspects of this disclosure are directed to reducing spoilage of single-application codes using automated injection via a modified user interface. This disclosure presents a system and method to modify a user interface, e.g., such that single-application codes may be utilized in an unobtrusive manner that reduces a risk of spoliation. In an example, the actual single-application code is withheld from the user and/or the application, browser, website, or the like used by the user, and instead is injected into an interaction (such as into an electronic communication) between the user and an entity.

Reference to any particular activity is provided in this disclosure only for convenience and not intended to limit the disclosure. A person of ordinary skill in the art would recognize that the concepts underlying the disclosed devices and methods may be utilized in any suitable activity. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially” and “generally,” are used to indicate a possible variation of +10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Terms like “provider,” “merchant,” “vendor,” “entity,” or the like generally encompass an entity or person involved in providing, selling, and/or renting items to persons such as a seller, dealer, renter, merchant, vendor, or the like, as well as an agent or intermediary of such an entity or person. An “item” or “object” generally encompasses a good, service, or the like having ownership or other rights that may be transferred. As used herein, terms like “user” or “customer” generally encompasses any person or entity that may desire information, resolution of an issue, purchase of a product, or engage in any other type of interaction with a provider. The term “browser extension” may be used interchangeably with other terms like “program,” “electronic application,” or the like, and generally encompasses software that is configured to interact with, modify, override, supplement, or operate in conjunction with other software.

As used herein, a “machine-learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine-learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration.

The execution of the machine-learning model may include deployment of one or more machine-learning techniques, such as linear regression, logistical regression, random forest, gradient boosted machine (GBM), deep learning, and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

In an example, a first entity may provide one or more items to users via an e-commerce server accessible via a first electronic application. One or more incentives may be associated with the first entity, with one or more items provided by the first entity, and/or one or more categories of items provided by the first entity. For example, a second entity may desire for users to use a particular interaction instrument (e.g., a particular credit card) when conducting interactions with the first entity, and so may desire to provide incentives to users that do so. The second entity may obtain, e.g., from the first entity, a limited quantity of single-use codes for such incentives that are usable via the first electronic application. Conventionally, the second entity might provide such single-use codes to users directly. However, such provision may result in spoliation, as not all users provided with a single-use code may actually complete an interaction with the first entity. Thus, the second entity may benefit from a technique to reduce the risk of such spoliation. As discussed in further detail below, one approach for doing so includes modifying a user interface for user devices operating the first electronic application.

In an exemplary use case, a user may operate the first electronic application on a user device, e.g., in order to access offers to one or more items provided by the first entity. Additionally, a second electronic application associated with the second entity may also operate on the user device. The second electronic application may be configured to monitor the operation of the first electronic application, e.g., an electronic session of the first electronic application initiated on the user device. The second electronic application may determine, based on the monitoring, one or more characteristics of the electronic session, e.g., an identification of the first entity, a website visited by the first electronic application, a category of items or a particular item browsed by the user, etc.

Based on such information, the second electronic application may obtain data corresponding to one or more single-use codes applicable to the electronic session, e.g., to an interaction between the user and the first entity. However, unlike a conventional system, the second application may withhold the data from one or more of the user, the electronic session, the first electronic application, etc. Instead, the second electronic application may wait, e.g., until detecting via the monitoring that the user has activated a user interface element on the first electronic application to complete the interaction (e.g., a checkout button or the like).

Upon such detection, the second electronic application may interrupt a response of the activation by the first electronic application, and inject an execution of the single-use code. For instance, activating a checkout button or the like may be configured to cause the first electronic application to initiate a communication to the e-commerce server. The second electronic application may interrupt such communication, inject code or data into the communication configured to cause execution of the single-use code, and then cause the communication to resume. In this manner, single-use codes may only be executed for interactions that are known to be subject to completion. Moreover, such execution may be conducted unobtrusively to the user.

In some embodiments, when a single-use coupon is available, the second electronic application may be configured to modify one or more aspects of the graphical user interface of the first electronic application. For instance, a notification regarding the availability and/or effect of the code may be displayed, e.g., via a pop-up window, an insert into a display for an item, into an interface element such as the checkout button, etc. In this manner, availability for a single-use code may be conveyed without providing the code and risking spoliation. In some embodiments, the second electronic application may be configured to determine availability of a code and obtain the code as separate steps, e.g., such that availability may be determined when a user is browsing an item but the code is not obtained until activation of the interface element to complete an interaction is detected.

Although the examples above involve incentive identification surrounding an e-commerce interaction, it should be understood that the techniques presented in this disclosure can be adapted to any suitable type of activity for which a single-use code may be applicable such as, for example, security, authentication, etc. It should also be clarified that these examples are purely illustrative. The technologies and methodologies of this disclosure can be adapted to any suitable activity.

The following sections discuss various aspects of machine-learning techniques that can be adapted for incentive identification. In more detail, machine-learning techniques adapted for incentive identification based on transactional and/or behavioral data may incorporate one or more aspects according to this disclosure. This can include a specific choice of training data, a distinct training process for the machine-learning model, the operation of a specific device compatible with the trained machine-learning model, the operation of the machine-learning model in conjunction with particular data, modification of such specific data by the machine-learning model, etc., and/or other aspects that may be apparent to those of ordinary skill in the art based on this disclosure.

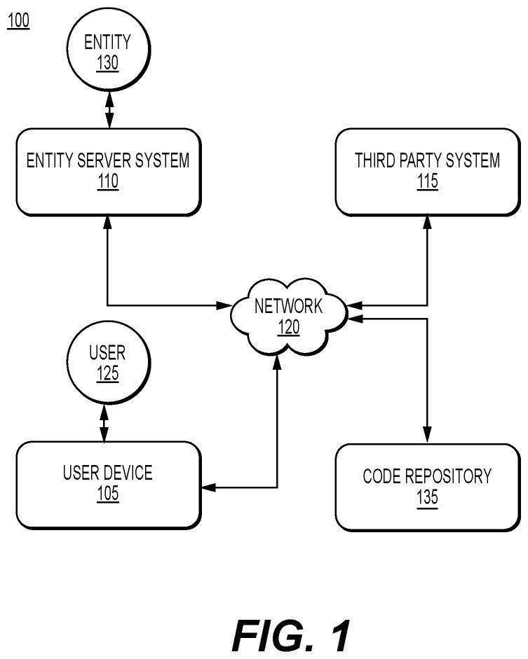

FIG. 1 depicts an exemplary embodiment of an environment 100 that may be utilized with techniques presented herein for modifying a user interface, e.g., to reduce spoilage of single-application codes using automated injection via a modified user interface. The environment may include, for example, a user device 105, an entity server system 110, a third party system 115, and an electronic network 120. The user device 105 may be associated with a user 125, and the entity server system 110 may be associated with an entity 130. As will be discussed in further detail below, the environment 100 may further include a code repository system 135. Components of the environment 100 may communicate with one or more of the other components of the environment 100 across the electronic network 120.

In some embodiments, the components of the environment 100 are associated with a common entity, e.g., a financial institution, transaction processor, vendor, or the like. In some embodiments, one or more of the components of the environment 100 is associated with a different entity than another. The systems and devices of the environment 100 may communicate in any arrangement. As will be discussed herein, systems and/or devices of the environment 100 may communicate to perform one or more activities such as modifying a user interface of the user device 105, facilitating execution of single-use codes while reducing a risk of spoliation, etc.

The user device 105 may be configured to enable the user 125 to access and/or interact with other components in the environment 100. For example, the user device 105 may be a computer system such as, for example, a desktop computer, mobile device, tablet, smart device, and the like. In some embodiments, the user device 105 may one or more electronic application(s), e.g., a program, plugin, browser extension, etc. In some embodiments, the electronic application(s) may be associated with one or more of the other components in the environment 100. For example, the electronic application(s) may include an e-commerce application configured to access one or more offers for items provided by the entity server system 110 or the like. As discussed in further detail below, the user device 105 may further include a Monitoring and Injection (Mal) electronic application configured to monitor and/or modify operation of other electronic applications operating on the user device 105.

The entity server system 110 may host an online resource such as e-commerce store, or the like that is accessible via the electronic network 120. The entity server system 110 may include one or more servers, datacenters, load balancers, etc. In some instances, at least a portion of the online resource may be implemented using cloud resources or the like. The entity server system 110 may be configured to interact with an electronic application, e.g., the e-commerce application operating on the user device 105.

In some instances, the entity 130 associated with the entity server system 110 may provide or offer incentives that can be activated using as single-use codes that the e-commerce application is configured to receive and that the entity server system 110 is configured to execute. In some instances, as discussed in further detail below, another entity unassociated with the entity server system 110 may facilitate execution of a single-use code. For instance, a financial service entity may offer an incentive for cash-back or the like for interactions that use a particular interaction instrument.

In various embodiments, the electronic network 120 may be a wide area network (“WAN”), a local area network (“LAN”), personal area network (“PAN”), or the like. In some embodiments, the electronic network 120 includes the Internet, and information and data provided between various systems occur online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks-a network of networks in which a party at one computer or other device connected to the network can obtain information from any other computer and communicate with parties of other computers or devices. The most widely used part of the Internet is the World Wide Web (often abbreviated “WWW” or called “the Web”). A “website page” generally encompasses a location, data store, or the like that is, for example, hosted and/or operated by a computer system so as to be accessible online, and that may include data configured to cause a program such as a web browser or electronic application to perform operations such as send, receive, or process data, generate a visual display and/or an interactive interface, or the like.

The third party system 115 may include one or more servers, devices, etc., configured to provide, for example, one or more of supplemental data, services, or functionality to the environment 100. For example, the third party system 115 may include a recommendation system configured to store user-related information, such as information related to user preferences, purchase history, promotional activities, or other input from one or more users. Other examples may include a price comparison system, a notification system, a financial services system such as a banking, credit card, or transaction system, etc. In various embodiments, the third party system 115 may store or be configured to obtain historical user data, transaction data, financial data, entity information such as stock, prices, incentives, item information, item comparison or price comparison data, or the like.

The code repository system 135 may include one or more servers, devices, etc., configured to obtain, track, and/or provide, for example, single-use codes for one or more interactions for one or more entities. The code repository system 135 may include, for example, a data store, database, or the like that logs single-use codes, whether such codes are available or expired, entities, items, or categories of items such codes are applicable to, benefits or value provided by such codes, and/or any other applicable information. In some embodiments, the code repository system 135 includes an algorithm, e.g., a machine-learning model that is configured to automatically obtain single-use codes from one or more entities. For example, the code repository system 135 may be configured to automatically obtain more single-use codes for a particular entity, item, or category in response to applicable codes running out or running low or being predicted to do so. In an example, the code repository system 135 may be configured to communicate with one or more other components of the environment 100 in order to obtain data usable as input to the algorithm or model, e.g., historical user transaction or interaction data, user profile data, item stock data from one or more entities, incentives provided by one or more entities, event data such as holidays or seasonal trends, and/or patterns or trend data based on the foregoing.

In some embodiments, the code repository system 135 is configured to communicate with one or more elements of the environment 100 via an Application Programming Interface (API). For example, in some embodiments, the code repository system 135 is configured to receive and respond to requests for single-use codes, e.g., from the Mal electronic application, as discussed in further detail below. In some embodiments, the code repository system 135 hosts, is configured to communicate with, or is otherwise associated with the Mal electronic application. In some embodiments, the Mal electronic application is hosted, in communication with, or otherwise associated with another system, e.g., as an intermediary or via any suitable arrangement. As discussed in further detail below, the Mal electronic application may be configured to interact with and/or modify operation of one or more other electronic applications, e.g., the e-commerce electronic application.

Although depicted as separate components in FIG. 1, it should be understood that a component or portion of a component in the environment 100 may, in some embodiments, be integrated with or incorporated into one or more other components. For example, a portion of the user device 105 may be integrated into the entity server system 110 (e.g., via the e-commerce electronic application), a portion of the code repository system 135 may be integrated into the entity server system 110, the third party system 115, or the like. Any suitable arrangement, distribution, and/or integration of the various systems and devices of the environment 100 may be used.

Further aspects of the techniques and components described above are discussed in further detail in the methods below. In the following methods, various acts may be described as performed or executed by a component from FIG. 1, e.g., the user device 105, entity server system 110, etc., or components thereof. However, it should be understood that in various embodiments, various components of the environment 100 discussed above may execute instructions or perform acts including the acts discussed below. An act performed by a device may be considered to be performed by a processor or the like associated with that device. Further, it should be understood that in various embodiments, various steps may be added, omitted, and/or rearranged in any suitable manner.

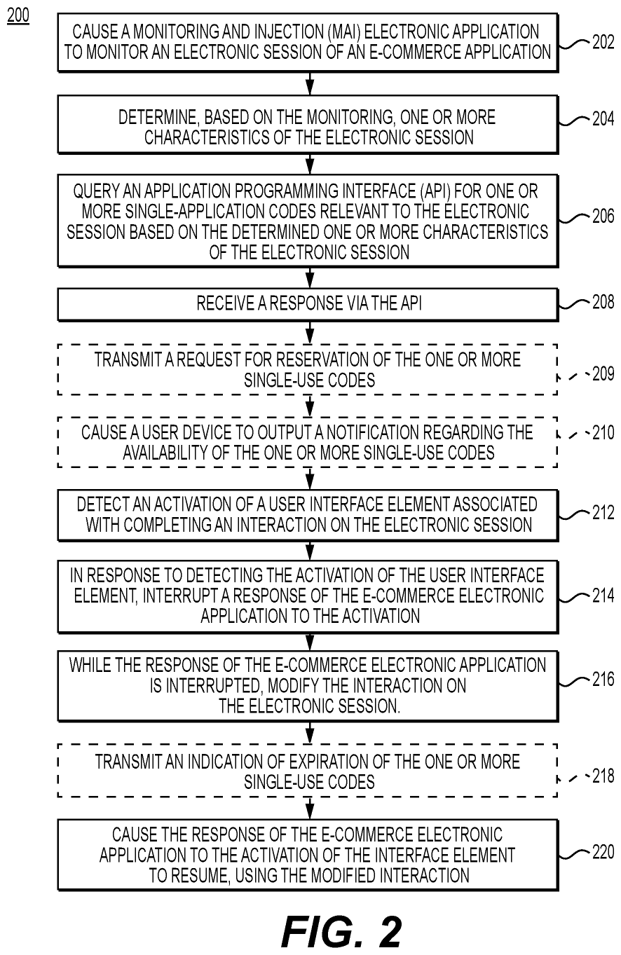

FIG. 2 illustrates an exemplary process 200 for modifying a user interface, e.g., to reduce spoliation of single-use codes. The exemplary process 200 may be a computer-implemented method, and may be considered a method for improving various technologies such as under interfaces, integration between a user interface and external systems, databases and tracking of single-use codes, etc. An entity 130 may, via an entity server system 110, host an online resource such as an e-commerce platform or the like. A user 125 may execute an e-commerce electronic application via a user device 105. In an example, the e-commerce electronic application is configured to access the online resource via the electronic network 120. Further, the user device 105 may include a Mal electronic application. At step 202, the user device may cause the Mal electronic application to monitor an electronic session of the e-commerce electronic application. As used herein, a “session” generally encompasses a collection of interactions of a user associated with an instance with a browser or electronic application. Data associated with a session may include, for example, data identifying the user, online resources visited by the user such as browsing history, interactions executed by the user, authentication information, etc.

In some embodiments, such monitoring is initiated in response to detecting a launching of the e-commerce electronic application on the user device 105. In some embodiments, the Mal electronic application may be launched or activated by the user 125, and or may operate continuously or intermittently in a background context of the user device 105. In some embodiments, the Mal electronic application is integrated with, associated with, or initialized by a further electronic application. For example, in some embodiments, the user 125 may sign up for or opt-in to an incentive program for providing single-use codes to users, e.g., via a banking application, incentive application, or the like.

At step 204, the user device 105 may determine, via the Mal electronic application and based on the monitoring of step 202, one or more characteristics of the electronic session, e.g., at least a portion of the data associated with the session and/or the online resource visited during the session. The one or more characteristics may include, for example, one or more of a website address visited during the electronic session, an item or category of items associated with the electronic session, a user interaction during the electronic session, a presence of a code field in a user interface of the electronic session, or a pattern or grouping thereof. In an exemplary embodiment, at least a portion of the data associated with the electronic session may be extracted by the Mal electronic application, and provided as input to an algorithm such as a machine-learning model (operating locally on the user device 105 and/or on another system such as the code repository system 135 or another system) that is configured to identify whether the user 125 is likely interested in obtaining an item or category of item from the entity 130. Such algorithm may return information regarding such item or category, or the like, as the one or more characteristics.

At step 206, the user device may, via the Mal electronic application, query an Application Programming Interface (API) for one or more single-application codes relevant to the electronic session based on the determined one or more characteristics of the electronic session. The API may be associated with the code repository system 135, or the like. For instance, the Mal electronic application may, at step 204, determine that the user 125 is using the e-commerce electronic application associated with an entity 130 to browse an e-commerce platform hosted by the entity server system 110, to browse a particular item or category of items thereon, and/or may capture other information associated with the electronic session. Then, at step 206, the Mal electronic application may generate an API request based on the obtained data and transmit the generated API request to the code repository system 135.

In some embodiments, the API request includes a request for information regarding code availability. In some embodiments the API request includes a request for provision of one or more available codes. At step 208, the user device 105, via the Mal electronic application, may receive a response via the API, e.g., one or more of the information regarding code availability or the one or more available codes. The response may also include, for example, information associated with the one or more available codes, such as applicable items or categories of items, criteria for use, benefit or value to the user, window of availability, etc. In some embodiments, as noted above, the code repository system 135 may determine that a code associated with a response has an applicability that is or is likely to be in limited supply, and may be configured to automatically obtain more code with similar applicability. In some embodiments, the code repository system 135 is configured to limit a quantity or rate of responses for codes with a similar applicability, e.g., in order to reduce a risk of a code no longer being available after an availability was indicated in a previous response.

In some embodiments in which the response includes one or more single-use codes, the user device 105, e.g., via the Mal application, may store the one or more single-use codes such that the one or more single-use codes is hidden from or not visible or accessible by the electronic session, the user 125, or the like.

Optionally, e.g., in embodiments in which the response includes information regarding availability of the one or more single-use codes, at step 209, the Mal application may be configured to transmit a request, e.g., via the API, for reservation of the one or more single-use codes, e.g., such that the one or more single-use codes are not sent used with a different interaction. In some embodiments, such reservation may expire after a predetermined period of time. In some embodiments, the Mal application may be configured to release the reservation, e.g., in response to determining that the user 125 has cancelled the interaction, exited the electronic session, or the like without the one or more single-use codes being executed.

Optionally, at step 210, the Mal application may be configured to cause the user device 105 to output a notification regarding the availability of the one or more single-use codes. In some embodiments, the Mal application may be configured to inject the notification into the electronic session and/or cause the e-commerce electronic application to display the notification. In some embodiments, the Mal application may be configured to cause the user device 105 to output the notification, e.g., as a push notification, text message, email, audio or visual cue, etc. The notification may include, for example, a visual or auditory notification, or the like. The notification may include, for example, information regarding availability of one or more single-use codes, criteria and/or an effect of the one or more single-use codes, or any other suitable information pertaining to the one or more single-use codes.

In some embodiments, the method may involve injecting code to change an appearance and/or layout of certain elements of a checkout page, e.g., with the aim of encouraging user adoption of coupon codes or other incentives. Such changes may include modifying the appearance of text, font characteristics, button styles, layout of elements, or the like.

For example, the method may modify the font characteristics of a coupon code input field or a promotional message, such as altering the font size, color, style, or weight, to draw the user's attention to the input field or message. Similarly, button styles associated with applying the coupon code or engaging with the promotional notification may be adjusted to make them more visually appealing or noticeable, such as changing the button color, shape, or size.

In some embodiments, outputting the notification may include the Mal application causing the e-commerce electronic application to alter a layout or contents of elements on an interface or display such as a checkout page. Such alteration may include, for instance, repositioning a coupon code input field, inserting or modifying a promotional message, relocating a button or interface element, altering or adding text content, or the like. In an example, the alteration may include altering a “check-out” or “pay now” button to include information such as “with a coupon code,” “with savings applied,” or the like. In other words, in some embodiments, the alteration may include modifying an interface element of the electronic session to include a visual indication of an executing of at least one of the one or more single-use codes.

The notification may be displayed at any suitable time. In one example, the Mal application is configured to cause the notification to be displayed upon determining the availability of the one or more single-use codes. In some embodiments, such display may thus occur prior to the user 125 reaching a checkout page or initiating a check-out or payment procedure.

In some embodiments, the Mal application may be configured to determine a point in time when the user 125 is more likely to be receptive to or engage with the notification. For example, the electronic session may be described as or represented as an interaction pathway, e.g., a sequence of interactions by the user 125 with the electronic session and/or responses to such interactions by the e-commerce electronic application. In some embodiments, the Mal application may be configured to compare one or more of such interactions and/or one or more patterns of such interactions to interactions or patterns predetermined to be associated with a user that is likely to be receptive to or to engage with a notification. Such predetermined interactions or patterns may be based on, for example historical browsing or transaction information of the user and or individuals other than the user. For instance, a propensity to click on promotional notifications, a history of completing purchases when presented with discounts or incentives may be taken into account. In some embodiments, behaviors of the user 125 within the current electronic session are utilized. Another exemplary interaction that may be used to determine a timing for the notification may include, for example, an action by the user 125 indicating that they are going to leave a current page or display, such as a cursor controlled by the user 125 pathing towards a close or exit button. Another behavior that may be considered includes a dwell time of the user 125, such as spending more than a predetermined period of time observing a website page or display of a particular item or category of items. Any other suitable criteria for displaying a notification may be used. For example, a notification may be withheld or delayed if a previous notification from the Mal application was displayed within a predetermined period of time.

In some embodiments, the criteria for whether and/or when to display the notification may be user-specific, e.g., based on information or history specific to the user 125 or indicated by the user 125 in a user profile or settings associated with the Mal application. In some embodiments, the criteria for whether and/or when to display the notification may be determined, at least in part, based on a machine-learning model. For example, the machine-learning model may be trained, based on historical user interactions or browsing data of the user 125 and or other individuals, to identify a point in an interaction pathway when the user 125 is likely to be receptive to or engage with a notification.

At step 212, the user device 105, via the Mal electronic application and based on the monitoring, may detect an activation of a user interface element associated with completing an interaction on the electronic session. For example, the user 125 may interact with a “checkout” button, a “pay now” button, a “submit” button, or the like.

At step 214, in response to detecting the activation of the user interface element, the Mal application may be configured to interrupt a response of the e-commerce electronic application to the activation. For instance, a “checkout” button may be configured such that, when activated, the e-commerce electronic application operating on the user device 105 transmits a checkout request message, e.g., to the entity server system 110. Instead, the Mal application may intercept, delay, and/or block such request message.

At step 216, while the response of the e-commerce electronic application is interrupted, the Mal application may be configured to modify the interaction on the electronic session. In some embodiments, such as embodiments where the response from the API received at step 208 included information regarding availability of a single-use code but not the code itself, modifying the interaction may include transmitting a request via the API for the one or more single-use codes, and then receiving the one or more single-use codes.

The modifying may further include, for example, injecting execution of at least one of the one or more single-application codes into the interaction, e.g., into one or more of the checkout request message, the electronic session, or the e-commerce electronic application. In an example, the checkout request from the e-commerce electronic application may be modified to include computer-code configured to cause the e-commerce electronic application to apply one or more single-use codes to the interaction. In a further example, the Mal application may cause entry of the one or more single-use codes in a code field displayed by the electronic session of the e-commerce electronic application. In another example, executing the one or more single-use codes may include transmitting a query based on the one or more single-application codes to the entity server system 110, e.g., separate from the checkout request. In some embodiments, the query may be transmitted via the user device 105. In some embodiments, the query may be transmitted by another system, e.g., the code repository system 135 or the like. In some embodiments, the other system may transmit the query in a manner such that the query appears to have originated from the user device 105. In some embodiments, the interruption of the response of the e-commerce electronic application may persist until the user device 105 receives an indication regarding a response to the executing of the one or more single use codes. For instance, the Mal application may continue the interruption until receiving a response to the query discussed above. In other embodiments, such as embodiments in which executing of one or more single-use codes is injected into the checkout request or the like, the interruption may persist while the checkout request is being modified.

Optionally, at step 218, the Mal application may transmit an indication of expiration of the one or more single-use codes, e.g., to the code repository system 135, to the API, or the like. In some embodiments, execution of the one or more single-use codes automatically causes expiration thereof.

At step 220, the Mal application may be configured to cause the response of the e-commerce electronic application to the activation of the interface element to resume, using the modified interaction. In this manner, for example, the Mal application may be used to execute a single-use code without requiring an active interaction of the user, and/or without exposing the single-use code before it can be assured that a corresponding interaction with the e-commerce store will be completed, each of which may act to reduce spoliation of such single-use codes.

In some embodiments, the Mal application may be configured to collect various types of analytics data related to interactions and behaviors of the user 125. Such analytics data may be used to assess the effectiveness of the Mal application, improve its performance, and/or optimize user engagement. Some examples of analytics data that may be collected by the Mal application include, but are not limited to:

Checkout Metrics: The Mal application may be configured to monitor and/or record a number of users who complete a checkout process with and without applying a provided single-use coupon code or other incentives. This data can help assess the effectiveness of the incentives in driving conversions and user satisfaction, as well as inform future incentive strategies.

User Behavior and Interactions: The Mal application may be configured to analyze user interactions with a checkout page, notifications, etc., e.g., to determine which interactions lead to conversions and which do not. Such information may be used to optimize the design, layout, and content of modifications to the checkout page, promotional materials, and/or the timing or delivery of notifications.

A/B Testing: The Mal application may be used for or in conjunction with A/B testing, e.g., to measure consumer satisfaction and dissatisfaction related to various aspects of interactions, such as the timing of notifications or the layout of the checkout page.

It should be understood that embodiments in this disclosure are exemplary only, and that other embodiments may include various combinations of features from other embodiments, as well as additional or fewer features. Moreover, while one or more examples above pertain to modification of an interaction/interface of an e-commerce electronic application, one or more aspect of techniques disclosed herein may be adapted to any suitable use, e.g., for modification of an interaction/interface of any suitable electronic application.

In general, any process or operation discussed in this disclosure that is understood to be computer-implementable, such as the processes illustrated in FIG. 2, may be performed by one or more processors of a computer system, such any of the systems or devices in the environment 100 of FIG. 1, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

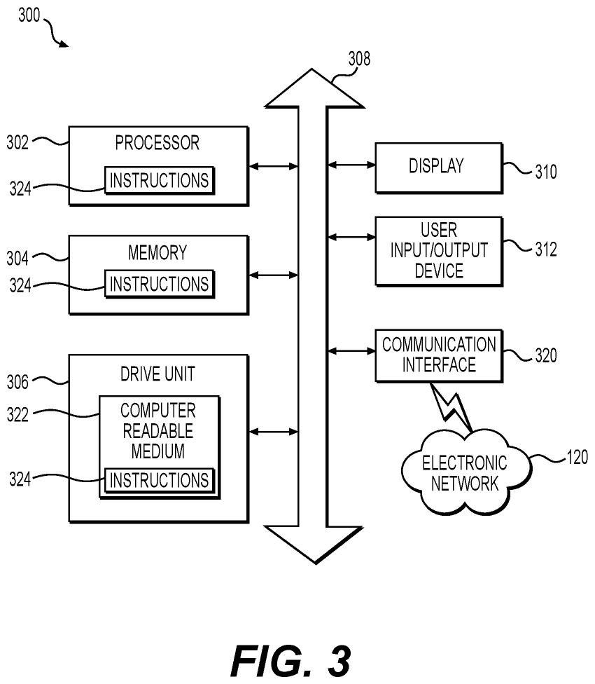

FIG. 3 is a simplified functional block diagram of a computer 300 that may be configured as a device for executing the methods of FIG. 2, according to exemplary embodiments of the present disclosure. In various embodiments, any of the systems herein may be a computer 300 including, for example, a data communication interface 320 for packet data communication. The computer 300 also may include a central processing unit (“CPU”) 302, in the form of one or more processors, for executing program instructions. The computer 300 may include an internal communication bus 308, and a storage unit 306 (such as ROM, HDD, SDD, etc.) that may store data on a computer readable medium 322, although the computer 300 may receive programming and data via network communications. The computer 300 may also have a memory 304 (such as RAM) storing instructions 324 for executing techniques presented herein, although the instructions 324 may be stored temporarily or permanently within other modules of computer 300 (e.g., processor 302 and/or computer readable medium 322). The computer 300 also may include input and output ports 312 and/or a display 310 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed embodiments may be applicable to any environment, such as a desktop or laptop computer, an automobile entertainment system, a home entertainment system, etc. Also, the disclosed embodiments may be applicable to any type of Internet protocol.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method for modifying a user interface, comprising:
causing a first electronic application operating on a user device to monitor an electronic session of a second electronic application operating on the user device;
determining, via the first electronic application and based on the monitoring, one or more characteristics of the electronic session;
querying, via the first electronic application and using the determined one or more characteristics, an Application Programming Interface (API) for one or more single-application codes relevant to the electronic session;
receiving, from the API, the one or more single-application codes;
detecting, via the first electronic application and based on the monitoring, an activation of a user interface element associated with completing an interaction on the electronic session;
in response to the detecting of the activation:
interrupting a response of the second electronic application to the activation;
while the response is interrupted, modifying the interaction on the electronic session by injecting execution of at least one of the one or more single-application codes into the second electronic application; and
causing the response of the second electronic application to the activation to resume with the modified interaction.

2. The computer-implemented method of claim 1, wherein modifying the interaction on the electronic session further includes modifying the user interface element to include a visual indication of the executing of the at least one of the one or more single-application codes.

3. The computer-implemented method of claim 1, further comprising:
after executing the at least one of the one or more single-application codes, transmitting an indication of expiration of the at least one of the one or more single-application codes to the API.

4. The computer-implemented method of claim 1, further comprising:
prior to the detecting, causing the first electronic application to insert a visual notification into the electronic session that is indicative of one or more of an availability or effect of at least one of the one or more single-application codes on the interaction.

5. The computer-implemented method of claim 1, further comprising:
receiving, from the API, an indication of an availability of the at least one of the one or more single-application codes, wherein:
modifying the interaction further includes querying the API for at least one single-application code based on the indication of the availability; and
the receiving, from the API, of the one or more single-application codes occurs while the response is interrupted.

6. The computer-implemented method of claim 1, wherein the one or more single-application codes are stored so as to be hidden from the electronic session and a user of the electronic session.

7. The computer-implemented method of claim 1, wherein the one or more characteristics of the electronic session includes one or more of a website address visited during the electronic session, an item associated with the electronic session, a user interaction during the electronic session, a presence of a code field in a user interface of the electronic session, or a pattern or grouping thereof.

8. A computer-implemented method for modifying a user interface, comprising:
causing a first electronic application operating on a user device to monitor an electronic session of a second electronic application operating on the user device;
determining, via the first electronic application and based on the monitoring, that a user is engaged in an interaction to obtain an item offered by an entity via the electronic session;
querying, via the first electronic application, an Application Programming Interface (API) for an availability of one or more single-application codes relevant to the one or more of the item and the entity;
receiving, from the API, an indication of the availability of one or more single-application codes;
in response to receiving the indication of availability, causing the first electronic application to insert a visual notification into the electronic session that is indicative of one or more of an availability or effect of the one or more single-application codes on the interaction, wherein the one or more single-application codes are withheld from the user and the electronic session;
detecting, via the first electronic application and based on the monitoring, an activation of a user interface element associated with completing the interaction on the electronic session;
in response to the detecting of the activation:
interrupting a response of the second electronic application to the activation;
while the response is interrupted, modifying the interaction on the electronic session by injecting execution of at least one of the one or more single-application codes into the second electronic application in a background context such that the at least one of the one or more single-application codes is neither provided nor available to the user and to the electronic session; and
causing the response of the second electronic application to the activation to resume with the modified interaction.

9. The computer-implemented method of claim 8, wherein the determining that a user is engaged in the interaction is based on detection of one or more characteristics of the electronic session including one or more of a website address visited during the electronic session, an item associated with the electronic session, a user interaction during the electronic session, a presence of a code field in a user interface of the electronic session, or a pattern or grouping thereof.

10. The computer-implemented method of claim 8, further comprising, while the response is interrupted:
querying the API for the one or more single-application codes; and
receiving from the API the one or more single-application codes.

11. The computer-implemented method of claim 8, wherein modifying the interaction on the electronic session further includes modifying the user interface element to include a visual indication of the executing of the at least one of the one or more single-application codes.

12. The computer-implemented method of claim 8, further comprising:
after executing the at least one of the one or more single-application codes, transmitting an indication of expiration of the at least one of the one or more single-application codes to the API.

13. The computer-implemented method of claim 8, further comprising:
in response to receiving the indication of availability, transmitting a request via the API for reservation of the one or more single-application codes, the request configured to cause the API to not provide information pertaining to the one or more single-application codes in response to a request originating from another electronic session.

14. The computer-implemented method of claim 8, wherein executing at least one of the one or more single-application codes includes transmitting a query based on the one or more single-application codes to a system associated with the entity.

15. The computer-implemented method of claim 14, wherein the response is interrupted until a response to the query based on the one or more single-application codes is received from the system associated with the entity.

16. The computer-implemented method of claim 14, transmitting of the query is performed by a system remote from the user device.

17. A non-transitory computer-readable medium comprising instructions for modifying a user interface on a user device, the instructions executable by at least one processor of the user device to perform operations, including:
causing a first electronic application operating on the user device to monitor an electronic session of a second electronic application operating on the user device;
determining, via the first electronic application and based on the monitoring, one or more characteristics of the electronic session;
querying, via the first electronic application and using the determined one or more characteristics, an Application Programming Interface (API) for one or more single-application codes relevant to the electronic session;
receiving, from the API, the one or more single-application codes;
detecting, via the first electronic application and based on the monitoring, an activation of a user interface element associated with completing an interaction on the electronic session;
in response to the detecting of the activation:
interrupting a response of the second electronic application to the activation;
while the response is interrupted, modifying the interaction on the electronic session by:
injecting execution of at least one of the one or more single-application codes into the second electronic application; and
modifying the user interface element to include a visual indication of the executing of the at least one of the one or more single-application codes;
causing the response of the second electronic application to the activation to resume with the modified interaction; and
transmitting an indication of expiration of the at least one of the one or more single-application codes to the API.

18. The non-transitory computer-readable medium of claim 17, wherein the operations further include:
prior to the detecting, causing the first electronic application to insert a visual notification into the electronic session that is indicative of one or more of an availability or effect of at least one of the one or more single-application codes on the interaction.

19. The non-transitory computer-readable medium of claim 17, wherein the operations further include:
receiving, from the API, an indication of an availability of the at least one of the one or more single-application codes, wherein:
modifying the interaction further includes querying the API for at least one single-application code based on the indication of the availability; and
the receiving, from the API, of the one or more single-application codes occurs while the response is interrupted.

20. The non-transitory computer-readable medium of claim 17, wherein the one or more characteristics of the electronic session includes one or more of a website address visited during the electronic session, an item associated with the electronic session, a user interaction during the electronic session, a presence of a code field in a user interface of the electronic session, or a pattern or grouping thereof.
